(19) United States
(12) Patent Application Publication
(10) Pub. No.: US 2014/0233785 A1
(43) Pub. Date: Aug. 21, 2014

(54) Slim Protector and Slim Microspeaker Module Having the Same

(71) Applicant: EM-TECH Co., Ltd., Busan (KR)

(72) Inventors: In Ho Jeong, Changwon-si (KR); Yong Ju Ji, Gimhae-si (KR); Ho Yun Lee, Busan (KR)

(73) Assignee: EM-TECH Co., Ltd., Busan (KR)

(21) Appl. No.: 14/173,051

(22) Filed: Feb. 5, 2014

(30) Foreign Application Priority Data
Feb. 15, 2013 (KR) 1020130016379

(51) Int. Cl. H04R 1/02

(52) U.S. Cl. CPC H04R 1/02
USPC 381/386

(57) ABSTRACT

The present invention relates to a slim protector with a small thickness and a slim microspeaker having the same. The present invention provides a slim protector, which can reduce the thickness of a slim microspeaker by removing part of an injection product portion and exposing a steel portion to form a ledge for connecting a module case and the slim protector and allow the steel portion and the module case to engage other, and a slim microspeaker module having the same.

### PRIORITY CLAIM

The present application claims priority to Korean Patent Application No. 10-2013-0016379 filed on 15 Feb. 2013, the content of said application incorporated herein by reference in its entirety.

### TECHNICAL FIELD

The present invention relates to a slim protector which is made thin and a slim microspeaker having the same.

### BACKGROUND

Nowadays, multimedia devices such as TVs, smart phones, etc are being made thinner and slimmer overall. In line with this trend, microspeakers mounted on multimedia are required to have a slim profile.

FIGS. 1 and 2 are views showing a conventional microspeaker. A yoke 21, an inner ring magnet 22, an outer ring magnet 23, an inner ring top plate 24, and an outer ring top plate 25 are installed within a frame 10, and a voice coil 30 is placed in an air gap between the inner ring magnet 22 and the outer ring magnet 23, and vibrates vertically when power is applied to the voice coil 30. The voice coil 30 is mounted to the bottom side of a damper 50, and a side diaphragm 41 and a center diaphragm 42 are installed on the top and bottom sides of the damper 50, vibrate in synchrony with the vibration of the voice coil 30, and produce a sound. A protector 60 is connected to the top of the side diaphragm 41 and center diaphragm 42 to protect the parts located inside the speaker. The protector 60 includes a ring-shaped steel portion 61 with an opening 63 in the middle to emit sound, and a ring-shaped injection product portion 62, into which the steel portion 61 is insert injection-molded, and which is laminated on top of the frame 10, the outer periphery of the side diaphragm 41, and the outer periphery of the damper 50.

FIG. 3 is a view showing a connecting portion of a microspeaker and a module case according to the conventional art.

The protector 60 of the conventional microspeaker is connected to a module case 1100 and 1200 surrounding the exterior of the microspeaker. The module case 1100 and 1200 includes a lower module case 1100 and an upper module case 1200, and the upper module case 1200 has a ledge 1210 that projects inward than the outer circumference of the microspeaker and presses down the microspeaker from above. The protector 60 also has a ledge that engages the ledge 1210 of the upper module case 1200 so as to maintain its position relative to the module case 1100 and 1200 without deviating from its original position. The ledge of the protector 60 is a stepped portion 62a which is formed with a relatively small thickness on the outer edge of the injection product portion 62. As the ledge 1210 of the module case 1200 having a predetermined thickness is connected to the stepped portion 62a of the injection product portion 62, the thickness of the stepped portion 62a or the thickness of the ledge 1210 of the module case 1200 needs to be reduced in order to reduce the thickness of the microspeaker module. However, if the injection thickness of the stepped portion 62a becomes too small, its strength may get lower. Therefore, the stepped portion 62 needs to have an injection thickness of 0.15 mm or greater, and the introduction of a high-performance injector having high capacity is required.

### SUMMARY

An object of the present invention is to provide a slim protector, which can reduce the thickness of a slim microspeaker by removing part of an injection product portion and exposing a steel portion to form a ledge for connecting a module case and the slim protector and allow the steel portion and the module case to engage other, and a slim microspeaker module having the same.

Another object of the present invention is to provide a slim protector, which can prevent the creation of a gap between a portion for injection to the inside of a steel portion and a portion for injection to the outside of the steel portion by forming holes in the steel portion to increase the coupling force between the steel portion and the injection portion, and a slim microspeaker module having the same.

Yet another object of the present invention is to provide a slim protector, which improves bending strength by forming downward protruding ribs on the top side of a steel portion, and a slim microspeaker module having the same.

The present invention provides a slim protector equipped in a slim microspeaker module comprising a microspeaker and a module case surrounding the exterior of the microspeaker, the protector including: a ring-shaped injection product portion whose outer periphery is shaped to engage a frame and which is hollow in the center; and a steel portion which is insert injection-molded and connected to the injection product portion and which has a top side exposed to the inside of the injection portion, an outer peripheral portion being shorter in height than the top side, and a sloped side provided between the outer peripheral portion and the top side, wherein a ledge for engaging the module case is formed with the outer peripheral portion of the steel portion exposed by removing part of the injection product portion.

According to another aspect of the present invention, the outer peripheral portion and the sloped side are formed only in the portion exposed by removing the injection portion.

According to another aspect of the present invention, the sloped side includes via holes through which an injection product portion for injection to the inside of the steel portion and an injection product portion for injection to the outside of the steel portion are connected to prevent the creation of a gap between the steel portion and the injection portions inside and outside the steel portion.

According to another aspect of the present invention, downward protruding ribs are formed on the top side of the steel portion to improve bending strength.

Furthermore, the present invention provides a slim microspeaker module including: a microspeaker having the slim protector described above, a frame, a yoke, inner and outer ring magnets, inner and outer ring top plates, a voice coil, a diaphragm, and a terminal; and a module case surrounding the exterior of the microspeaker.

A slim protector and a slim microspeaker module having the same according to the present invention can reduce the overall thickness of a microspeaker module only by changing the shape of a ledge of the protector.

Those skilled in the art will recognize additional features and advantages upon reading the following detailed description, and upon viewing the accompanying drawings.

### BRIEF DESCRIPTION OF THE DRAWINGS

FIGS. 1 and 2 are views showing a conventional microspeaker.

FIG. 3 is a view showing a connecting portion of a microspeaker and a module case according to the conventional art.

FIGS. 4 and 5 are views showing a slim protector according to a first embodiment of the present invention.

FIGS. 6 and 7 are views showing a slim protector according to a second embodiment of the present invention.

FIGS. 8 and 9 are views showing a slim protector according to a third embodiment of the present invention.

FIG. 10 is a view showing a slim microspeaker module according to an embodiment of the present invention.

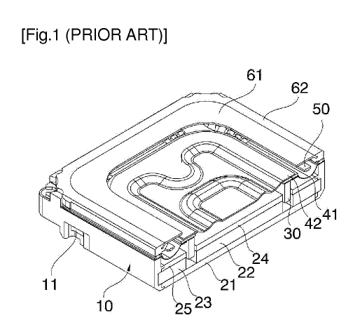

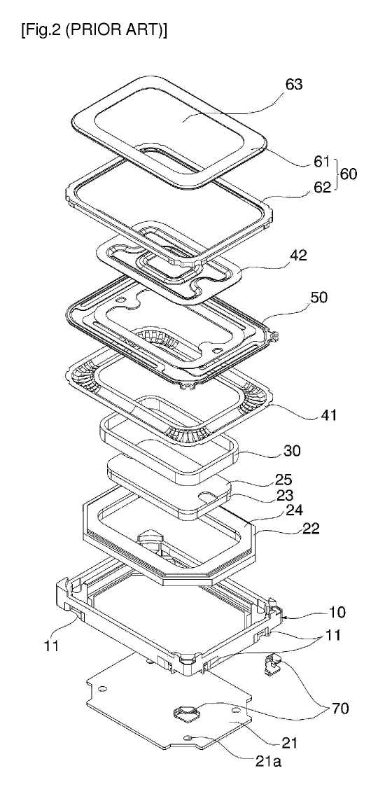

### DETAILED DESCRIPTION

Hereinafter, the present invention will be described in more detail with reference to the drawings.

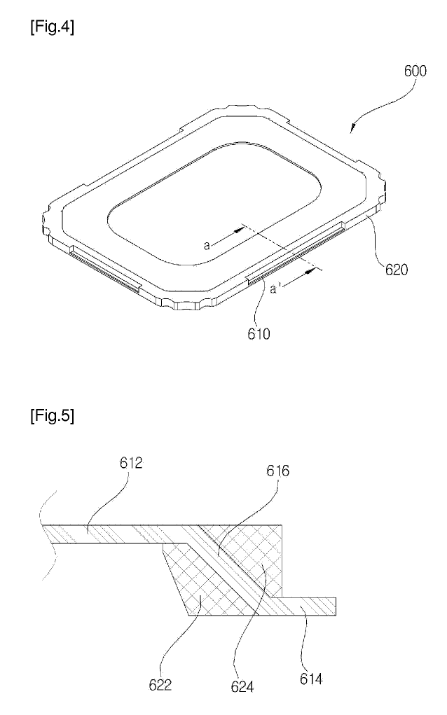

FIGS. 4 and 5 are views showing a slim protector 600 according to a first embodiment of the present invention.

The slim protector 600 according to the first embodiment of the present invention includes a steel portion 610 and an injection product portion 620. The steel portion 610 is made of a steel material having a predetermined strength to protect the parts inside a microspeaker, and has a top side 612 which is at a predetermined distance from parts such as a diaphragm. The steel portion 610 is insert injection-molded into the injection product portion 620, and the injection product portion 620 has the shape of a ring which is hollow in the center so as to expose the top side 612 of the steel portion 610.

The steel portion 610 includes the top side 612 exposed to the inside of the injection product portion 620, an outer peripheral portion 614 being shorter in height than the top side 612, and a sloped side 616 provided between the outer peripheral portion 614 and the top side 612.

To form a ledge that engages a ledge of the module case, in the slim protector 600 according to the first embodiment of the present invention, part of the outer side of the injection product portion 620 is removed, thereby exposing the outer peripheral portion 614 of the steel portion 610. As the exposed outer peripheral portion 614 and the ledge of the module case engage each other, the relative positions of the microspeaker and the module case can be fixed.

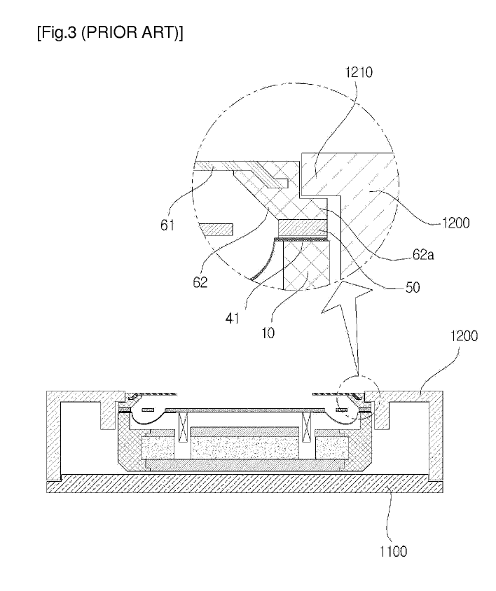

Referring to FIG. 3, in the conventional art, part of the injection product portion 62 is removed to cause the stepped portion 62a and the ledge 1210 of the module case 1200 to engage each other. This requires the stepped portion 62a to have a thickness of at least 0.15 mm to achieve a predetermined strength. On the other hand, the outer peripheral portion 614 of the slim protector 600 according to the first embodiment of the present invention can be made much thinner than the stepped portion 62a according to the conventional art because the outer peripheral portion 614 of the steel portion 610 and the ledge of the module case engage each other and steel has higher strength than an injection-molded material. Accordingly, an assembled slim microspeaker module can be made much slimmer.

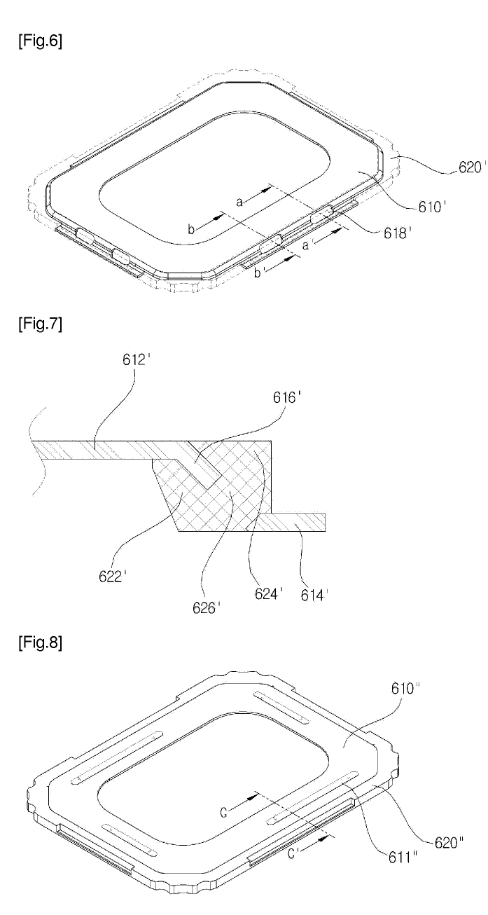

FIGS. 6 and 7 are views showing a slim protector according to a second embodiment of the present invention. Like in the first embodiment, the slim protector according to the second embodiment of the present invention includes a steel portion 610′ and an injection product portion 620′. However, the shapes of the steel portion 610′ and the injection product portion 620′ are somewhat different from those of the first embodiment. The slim protector according to the second embodiment of the present invention includes a top side 612′ exposed to the inside of the injection product portion 620′, an outer peripheral portion 614′ being shorter in height than the top side 612′, and a sloped side 616′ provided between the outer peripheral portion 614′ and the top side 612′. To form a ledge that engages a ledge of the module case, part of the outer side of the injection product portion 620′ is removed, thereby exposing the outer peripheral portion 614′ of the steel portion 610′. The outer peripheral portion 614′ is formed not over the entire area, but only in the portion from which the injection product portion 620′ is removed.

Further, as shown in FIG. 7, the injection product portion 620′ includes a lower injection product portion 622′ for injection to the bottom of the sloped side 616′ and an upper injection product portion 624′ for injection to the top of the sloped side 616′, both the lower injection product portion 622′ and the upper injection product portion 624′ being attached onto the steel portion 610′, which is a foreign material. Since the foreign material is adhered by insert injection-molding, the lower injection product portion 622′ and the upper injection product portion 624′ might fall off from the steel portion 610′, creating a gap between the lower and upper injection portions 622′ and 624′ and the steel portion 610′. To avoid this, via holes 618′ are formed on the sloped side 616′ of the steel portion 610′ in the protector according to the second embodiment. As an injection-molded material 626′ is filled in the via holes 618′ during injection-molding of the injection product portion 614′, the lower injection product portion 622′ and the upper injection product portion 624′ are connected by the injection-molded material 626′. This prevents the foreign material from falling off from the steep portion 610′ and creating a gap between the steep portion 610′ and the lower and upper injection portions 622′ and 624′.

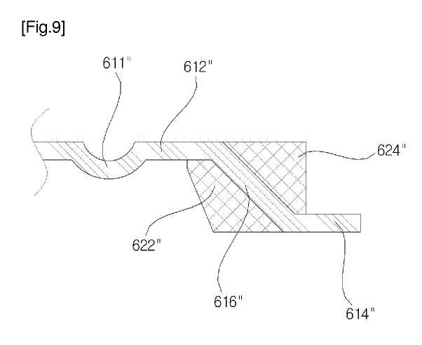

FIGS. 8 and 9 are views showing a slim protector according to a third embodiment of the present invention. Like in the first and second embodiments, the slim protector according to the third embodiment of the present invention includes a steel portion 610″ and an injection product portion 620″. However, the shape of the steel portion 610″ is somewhat different from those of the first and second embodiments. The slim protector according to the third embodiment of the present invention includes a top side 612″ exposed to the inside of the injection product portion 620″, an outer peripheral portion 614″ being shorter in height than the top side 612″, and a sloped side 616″ provided between the outer peripheral portion 614″ and the top side 612″. To form a ledge that engages a ledge of the module case, part of the outer side of the injection product portion 620″ is removed, thereby exposing the outer peripheral portion 614″ of the steel portion 610″.

The slim protector according to the third embodiment of the present invention includes a plurality of downward protruding ribs 611″ which are formed on the top side 612″ to increase the strength of the top side 612″ of the steel portion 610″. As the overall height of the slim microspeaker module decreases by making the steel portion 610″ thinner, the steel portion 610″ becomes weaker in bending strength. To compensate for this, a plurality of ribs 611″ are formed. The downward protruding ribs 611″ have an advantage over upward protruding ribs in reducing the overall height of the slim microspeaker module.

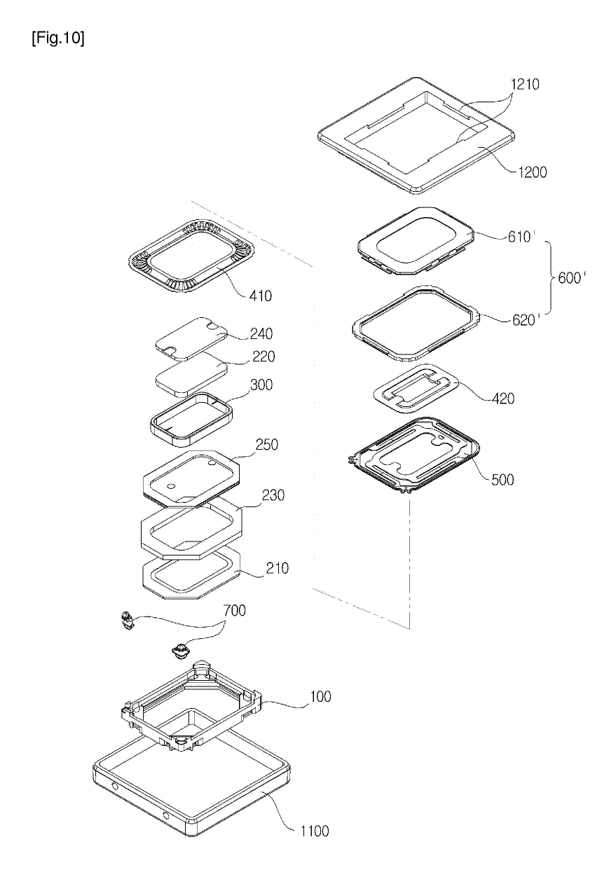

FIG. 10 is a view showing a slim microspeaker module according to an embodiment of the present invention.

The microspeaker is configured as follows. A magnetic circuit comprising of a yoke 210, an inner ring magnet 220, an outer ring magnet 230, an inner ring top plate 240, and an outer ring top plate 250 is installed within a frame 100.

A voice coil 300 is placed in an air gap between the inner ring magnet 220 and the outer ring magnet 230, and vibrates vertically when power is applied to the voice coil 300. The voice coil 300 is mounted to the bottom side of a damper 500, and a side diaphragm 410 and a center diaphragm 420 are installed on the top and bottom sides of the damper 500, vibrate in synchrony with the vibration of the voice coil 300, and produce a sound. A protector 600′ is connected to the top of the side diaphragm 410 and center diaphragm 420 to protect the parts located inside the speaker. Terminals 700 for receiving power from a device where the slim microspeaker module is mounted are installed on the frame 100.

The slim microspeaker module includes a lower module case 1100 to be connected to the bottom of the microspeaker and an upper module case 1200 to be connected to the top of the microspeaker. The upper module case 1200 includes a plurality of ledges 1210 that protrude upward of the microspeaker in order to prevent the microspeaker from falling out. Ledges for engaging the ledges 1210 are provided in the protector 600′. The ledges provided in the protector 600′ are formed by removing part of the outer side of the injection product portion 620′ and exposing the outer peripheral portion 614′ of the steel portion 610′.

While a slim microspeaker module according to an embodiment of the present invention employs the protector according to the second embodiment of the present invention, it also may employ the protector according to the first embodiment of the present invention or the protector according to the third embodiment of the present invention. Besides, a protector having two or more of the features of the protectors according to the first, second, and third embodiments may be employed.

Spatially relative terms such as “under”, “below”, “lower”, “over”, “upper” and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open-ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A slim protector configured for inclusion in a slim microspeaker module comprising a microspeaker and a module case surrounding the exterior of the microspeaker, the slim protector comprising:
a ring-shaped injection product portion having an periphery shaped to engage a frame and which is hollow in the center; and
a steel portion insert injection-molded and connected to the injection product portion, the steel portion having a top side exposed to the inside of the injection product portion, an outer peripheral portion being lower in height than the top side, and a sloped side provided between the outer peripheral portion and the top side,
wherein a ledge for engaging the module case is formed with the outer peripheral portion of the steel portion exposed by removing part of the injection product portion.

2. The slim protector as claimed in claim 1, wherein the outer peripheral portion is formed only in the portion exposed by removing the injection portion.

3. The slim protector as claimed in claim 1, wherein the sloped side comprises via holes through which an upper injection product portion for injection to the top of the sloped side and a lower injection product portion for injection to the bottom of the slope side are connected to prevent creation of a gap between the steel portion and the upper and lower injection portions of the sloped side.

4. The slim protector as claimed in claim 1, further comprising downward protruding ribs formed on the top side of the steel portion and which increase a bending strength of the steel portion.

5. A slim microspeaker module, comprising:
a microspeaker comprising a frame, a yoke, inner and outer ring magnets, inner and outer ring top plates, a voice coil, a diaphragm, a terminal and a slim protector comprising:
a ring-shaped injection product portion having an periphery shaped to engage a frame and which is hollow in the center; and
a steel portion insert injection-molded and connected to the injection product portion, the steel portion having a top side exposed to the inside of the injection product portion, an outer peripheral portion being lower in height than the top side, and a sloped side provided between the outer peripheral portion and the top side,
wherein a ledge for engaging the module case is formed with the outer peripheral portion of the steel portion exposed by removing part of the injection product portion; and
a module case surrounding the exterior of the microspeaker.

6. The slim microspeaker module as claimed in claim 5, wherein the outer peripheral portion of the slim protector is formed only in the portion exposed by removing the injection portion.

7. The slim microspeaker module as claimed in claim 5, wherein the sloped side of the slim protector comprises via holes through which an upper injection product portion for injection to the top of the sloped side and a lower injection product portion for injection to the bottom of the slope side are connected to prevent creation of a gap between the steel portion and the upper and lower injection portions of the sloped side.

8. The slim microspeaker module as claimed in claim 5, further comprising downward protruding ribs formed on the top side of the steel portion of the slim protector and which increase a bending strength of the steel portion.
